(19) United States
(12) Patent Application Publication
(10) Pub. No.: US 2002/0055300 A1
(43) Pub. Date: May 9, 2002

(54) Method of producing a reusable cable connection and, a cable connection provided with the use of method

(76) Inventor: Volker Scherb, Aspach (DE)

Correspondence Address: STRIKER, STRIKER & STENBY, 103 East Neck Road, Huntington, NY, 11743, US

(21) Appl. No.: 09/992,096

(22) Filed: Nov. 6, 2001

(30) Foreign Application Priority Data
Nov. 7, 2000 (DE) 100 55 102.5

(51) Int. Cl. H01R 13/52

(52) U.S. Cl. 439/523

(57) ABSTRACT

A reusable cable connection is produced by crimping ends of a cable; applying on free cable leads units selected from the group consisting of plug units and bush units; a fitting a heat-shrinking insulating hose over the cable ends; connecting the free cable leads via the units; displacing the heat-shrinking insulating hose over a plug connection formed by the units in a shrinking position; heating the heat-shrinking insulating hose so that both the free cable leads together with the plug connection as well as not crimped cable casing ends of the cables connected with one another are completely shrunk around.

### BACKGROUND OF THE INVENTION

The present invention relates to method of producing a reusable cable connection, as well as to a cable connection provided with the use of method.

For producing the reusable cable connections, in particular in high voltage applications, the cable connections are conventionally crimped, the free cable ends are soldered and shrunk. After a separation, the connecting cable can be again crimped, or in other words shortened, soldered and again shrunk. It is believed that the existing methods as well as cable connections can be further improved.

### SUMMARY OF THE INVENTION

Accordingly, it is an object of the present invention to provide a method of producing a reusable cable connection, as well as a cable connection produced by the inventive method, which avoid the disadvantages of the prior art.

More particularly, it is an object of present invention to provide a method for producing a reusable cable connection, as well as a cable connection produced by the inventive method, with which no shortening of the connection cable is needed.

In keeping with these objects and with others which will become apparent hereinafter, one feature of present invention resides, briefly stated, in a method of producing a reusable cable connection which includes the steps of crimping ends of a cable; applying on free cable leads units selected from the group consisting of plug units and bush units; fitting a heat-shrinking insulating hose over the cable ends; connecting the free cable leads via the units; displacing the heat-shrinking insulating hose over a plug connection formed by the units in a shrinking position; heating the heat-shrinking insulating hose so that both the free cable leads together with the plug connection as well as not crimped cable casing ends of the cables connected with one another are completely shrunk around.

In accordance with the present invention, after removal of the heat-shrunk insulating hose, the plug connection can be released and eventually after a repair of the components connected to the cable, a reestablishment of the connection is obtained in a simple manner. A piecing together and/or sealing of cable leads can be dispensed with.

The method in accordance with the present invention is suitable for a high voltage connection in a critical pressure region. In particular, in the regions where a highest possible reliability is required, for example in satellite systems, the present invention can be used with advantageous results.

In accordance with another feature of the present invention, a heat-hardenable material is applied on the cable casing ends before the shrinking. This provides a reliable sealing of the connection. Glow discharges in particular critical pressure regions, for example in phase minimum (intermediate pressure region) during a starting phase of a satellite, are efficiently suppressed.

The heat-hardenable material moreover provides a mechanical protection during the latter removal of the heat-shrinking isolating hose.

In accordance with another feature of the present invention, the shrinking is performed at a temperature which makes possible to glue the heat-shrinkable insulating hose with the not crimped cable ends, in some cases with the heat hardenable material applied before. This further increases the reliability of the sealing.

In accordance with still a further feature of the present invention, the insulating hose contains an adhesive or is coated with an adhesive at an inner side, in particular with an adhesive based on polyamide. With this solution the shrinking temperature can be held within conventional region.

The novel features which are considered as characteristic for the present invention are set forth in particular in the appended claims. The invention itself, however, both as to its construction and its method of operation, together with additional objects and advantages thereof, will be best understood from the following description of specific embodiments when read in connection with the accompanying drawings.

### BRIEF DESCRIPTION OF THE DRAWINGS

FIG. 1 is a view illustrating a principle of an inventive cable connection and a method for producing the connection.

### DESCRIPTION OF THE PREFERRED EMBODIMENTS

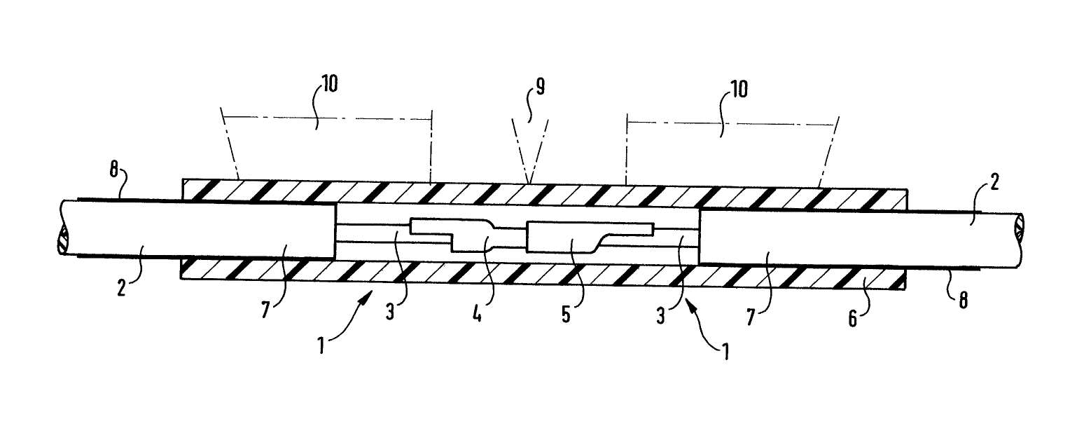

For producing a reusable cable connection shown in FIG. 1, the cable ends 1 of both cables 2 to be connected with one another are crimped. The thusly produced free cable leads 3 are provided with a plug unit 4 or with a bush unit 5 corresponding to the plug unit. The plug unit 4 and the bush unit 5 can be soldered in particular on the free cable leads.

Before the connection of the free cable leads via the plug connection, a heat-shrinking insulating hose 6 is fitted on one of the cable ends 1 and then the plug connection is produced. For the plug connection, high voltage plug units with associated bush end units for example of the company Cannon can be utilized. Subsequently, the heat-shrinking insulating hose 6 is displaced to a shrinking position, for example for this purpose it is displaced centrally over the plug connection.

The length of the heat-shrinking insulating hose 6 is selected so that it surrounds the plug connection, the free cable leads 3, as well as the not crimped cable casing ends 7 in a shrinking position. The heat-shrinking insulating hose 6 is heated, so that all elements which are surrounded by it are completely shrunk around.

In accordance with a preferable embodiment of the present invention, before the overshrinking, a heat hardenable material 8 is applied on the not crimped cable casing ends 7. In particular when the cable casing is composed of a soft material or when the surface is uneven, for example in the case of wound insulations, the tightness of the cable connection can be therefore increased. Especially a duroplast can be used as a heat-hardenable material 8, for example epoxy resin, with which the cable casing ends 7 are covered. The heat-hardenable material 8 acts during the heating as an adhesive and smoothes unevenness, since a smooth surface is critical for the later sealing. Furthermore, the heat-hardenable material 8 provides for a mechanical protection for the later removal of the insulating hose 6.

The shrinking temperature is selected for example so that the heat-shrinking insulating hose 6 can be glued with the not crimped cable casing ends 7 or with the heat-hardenable material 8 applied there. In the case of the use of a flexible heat-shrinking insulating hose 6 based on polyolefins, the shrinking temperature is more than twice the normal conventional shrinking temperature (>150° C.). The maximum permissible temperature for such heat-shrinking insulating hoses 6 must be naturally maintained.

If the insulating hose 6 is formed alternatively so that it contains an adhesive or is coated inwardly with an adhesive, then the shrinking temperature can be maintained in a conventional region. The adhesive is selected for example on polyamide base.

The present invention can be naturally used for multi connections. Several cable leads can be connected by plug connections and then over shrunk.

The connection or connections in accordance with the present invention can be separated in a simple manner. In particular, in the region of plug- and device 4, 5 (cutting region 9), the overshrunk insulating layer 6 can be cut approximately at ⅓ of the periphery with a scalpel or the like, and both ends can be pulled from one another. The continuous tearing sensitivity of conventional heat-shrinking insulating hoses is very high. The hose ends are sealed on the cables 2, by cutting/halfing in the region of the plug-or bush unit 4, 5 of the insulating hose 6 (cutting region 10) and pulling off with a tool, manually or with hot air.

The pulling off with hot air is especially advantageous when the insulating layer is coated at the inner side with an adhesive. The connection can be further established, for example after repair/exchange of the components connected to the cable 2 as described before.

The inventive connection can be formed for example as a high voltage connection of a traveling field tube with a power supply unit for a satellite, which both in the testing phase is released prior to the end mounting of the satellite and must be again produced, and also eventually in the desired orbit position.

The features of the present invention ensure that the connection is not damaged or destroyed in the starting phase of the satellite, in particular in critical intermediate pressure region (launch minimum) by glow discharge.

It will be understood that each of the elements described above, or two or more together, may also find a useful application in other types of methods and constructions differing from the types described above.

While the invention has been illustrated and described as embodied in Method of producing a usable cable connection as well as a cable connection provided with the use of method, it is not intended to be limited to the details shown, since various modifications and structural changes may be made without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

What is claimed as new and desired to be protected by Letters Patent is set forth in the appended claims:

1. A method of producing a reusable cable connection, comprising the steps of crimping ends of a cable; applying on free cable leads units selected from the group consisting of plug units and bush units; fitting a heat-shrinking insulating hose over the cable ends; connecting the free cable leads via the units; displacing the heat-shrinking insulating hose over a plug connection formed by the units in a shrinking position; heating the heat-shrinking insulating hose so that both the free cable leads together with the plug connection as well as not crimped cable casing ends of the cables connected with one another are completely shrunk around.

2. A method as defined in claim 1; and further comprising applying a heat-hardenable material on the cable casing ends prior to the overshrinking.

3. A method as defined in claim 2; and further comprising performing the overshrinking with a temperature which allows glueing of the heat-shrinking insulating hose with the not crimped cable casing ends and the heat hardenable material applied on them.

4. A method as defined in claim 1; and further comprising using the insulating hose which is formed as an insulating hose selected from the group consisting of a hose which contains an adhesive and a hose which is coated at an inner side with an adhesive based on polyamide.

5. A method as defined in claim 2; and further comprising using a duroplast as the heat-hardenable material.

6. A method as defined in claim 5; and further comprising using epoxy resin as the heat-hardenable material.

7. A method as defined in claim 1; and further comprising selecting the shrinking temperature more than twice a conventional shrinking temperature, when the heat-shrinking insulating hose based on polyalifin is used.

8. A reusable cable connection, comprising cable ends which are crimped in a region of a connection; units selected from the group consisting of plug units and bush units and provided on free cable leads; an insulating hose with which free cable leads in a plug condition are shrunk around, so that a heat-shrinking insulating layer surrounds both the free cable leads together with a plug connection composed of said units as well as not crimped cable casing ends of cables connected with one another.

9. A reusable cable connection as defined in claim 8; and further comprising a heat-hardenable material which surrounds the not crimped cable casing ends.

10. A reusable cable connection as defined in claim 8, wherein said insulating hose is formed as an insulating hose selected from the group consisting of an insulating hose which contains an adhesive and an insulating hose which is coated at an inner side with an adhesive.

11. A reusable cable connection of a traveling field tube with its power supply unit, comprising cable ends which are crimped in a region of a connection; units selected from the group consisting of plug units and bush units and provided on free cable leads; an insulating hose with which free cable leads in a plug condition are shrunk around, so that a heat-shrinking insulating layer surrounds both the free cable leads together with a plug connection composed of said units as well as not crimped cable casing ends of cables connected with one another.
